(19) United States
(12) Patent Application Publication
(10) Pub. No.: US 2015/0339638 A1
(43) Pub. Date: Nov. 26, 2015

(54) SYSTEM AND METHOD FOR PROVIDING SOCIAL CASH

(71) Applicant: Capital One Financial Corporation, McLean, VA (US)

(72) Inventor: Brian DeLUCA, Midlothian, VA (US)

(21) Appl. No.: 14/717,550

(22) Filed: May 20, 2015

Related U.S. Application Data
(60) Provisional application No. 62/000,666, filed on May 20, 2014.

(51) Int. Cl. G06Q 20/10; G06Q 20/32

(52) U.S. Cl. CPC G06Q 20/10; G06Q 20/32

(57) ABSTRACT

A system and method for facilitating dispensing social cash includes an application programming interface that receives a contact list, a communications processor that receives a request for a mobile cash dispenser from a user device, a location processor that provides location information to the user device indicating the location of one or more mobile cash dispensers, wherein each of the one or more mobile cash dispensers are associated with a respective contact in the contact list, an input interface that receives a selection from the user device of one of the one or more mobile cash dispensers, and a social cash processor in cooperation with the communications processor that facilitates an interaction between the user device and the selected mobile cash dispenser and receives transaction confirmation information from at least one of the user device and the mobile cash dispenser.

### RELATED APPLICATIONS

This application contains subject matter related to and claims the benefit of U.S. Provisional Patent Application No. 62/000,666, filed on May 20, 2014, the entire contents of which is incorporated herein by reference.

This application contains subject matter related to Provisional Application No. 61/924,392, filed on Jan. 7, 2014, the entire contents of which is incorporated herein by reference.

### FIELD OF THE DISCLOSURE

The present disclosure relates to systems and methods for allowing individuals to exchange physical cash for digital payments.

### BACKGROUND OF THE DISCLOSURE

Currently, if an individual wishes to obtain cash, he or she must find a physical automatic teller machine (ATM) or store where he or she can withdraw cash. The availability of cash is limited by the availability of nearby ATMs. Furthermore, some ATMs charge unreasonable fees for cash withdrawals. In some instances, ATMs may be located in unsafe or remote areas, making it difficult for an individual to access cash when he or she needs it.

These and other drawbacks exist.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts a schematic diagram of a system for enabling individuals to act as person-to-person cash dispensers (or “mobile ATMs”) and provide cash to nearby individuals in exchange for a digital payment, according to an example embodiment of the disclosure;

FIG. 2 depicts a schematic diagram of a system for enabling individuals to act as person-to-person cash dispensers and provide cash to nearby individuals in exchange for a digital payment, according to an example embodiment of the disclosure;

FIG. 3A depicts a screenshot of an interface on a user's device, according to an example embodiment of the disclosure;

FIG. 3B depicts a screenshot of an interface on a user's device, according to an example embodiment of the disclosure;

FIG. 3C depicts a screenshot of an interface on a user's device, according to an example embodiment of the disclosure;

FIG. 3D depicts a screenshot of an interface on a user's device, according to an example embodiment of the disclosure;

FIG. 3E depicts a screenshot of an interface on a user's device, according to an example embodiment of the disclosure;

FIG. 3F depicts a screenshot of an interface on a user's device, according to an example embodiment of the disclosure;

FIG. 3G depicts a screenshot of an interface on a user's device, according to an example embodiment of the disclosure;

FIG. 3H depicts a screenshot of an interface on a user's device, according to an example embodiment of the disclosure;

FIG. 3I depicts a screenshot of an interface on a user's device, according to an example embodiment of the disclosure;

FIG. 3J depicts a screenshot of an interface on a user's device, according to an example embodiment of the disclosure; and

FIG. 4 depicts a schematic diagram of a method for enabling individuals to act as person-to-person cash dispensers and provide cash to nearby individuals in exchange for a digital payment, according to an example embodiment of the disclosure.

### DETAILED DESCRIPTION OF THE EMBODIMENTS

The following description is intended to convey a thorough understanding of the embodiments described by providing a number of specific example embodiments and details involving systems and methods for enabling individuals to seek out physical cash from other individuals within their social networks to act in exchange for digital payment. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial institutions only.

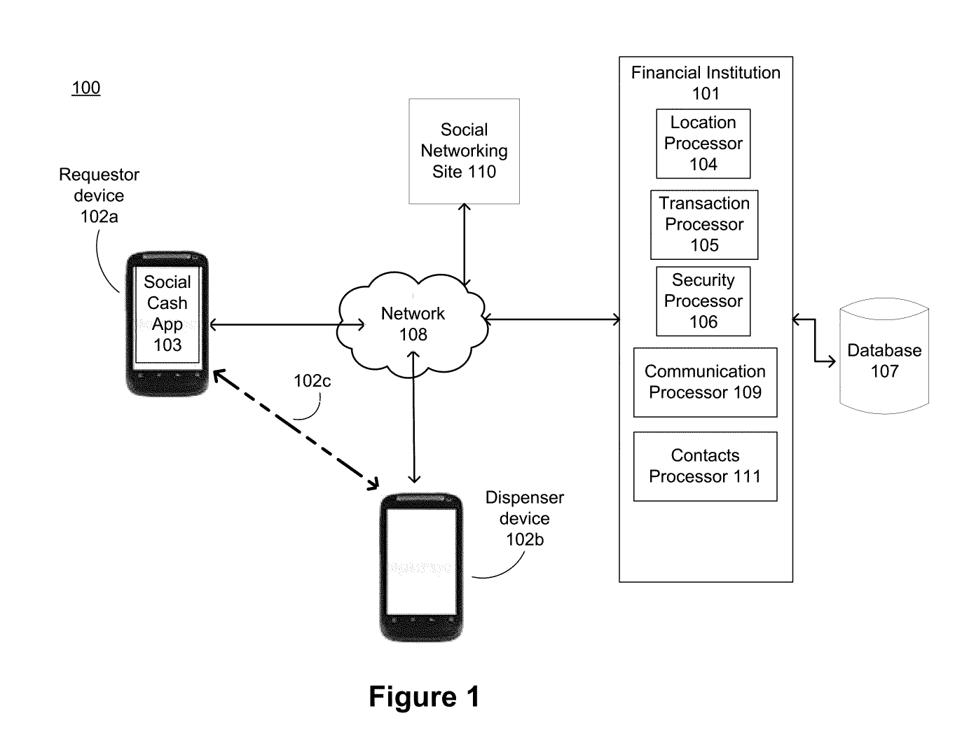

FIG. 1 depicts an example embodiment of a system 100 for enabling individuals to act as person-to-person cash dispensers and dispense physical cash to other individuals in exchange for digital payment, according to various embodiments of the disclosure. The system 100 may include various network-enabled computer systems, including, as depicted in FIG. 1 for example, a financial institution 101 (which may include, for example, location processor 104, transaction processor 105, security processor 106, communication processor 109, and social contacts processor 111), requestor device 102a, dispenser device 102b, network 108, a social networking site 110, and database 107. It is also noted that the system 100 illustrates only a single instance of each component. It will be appreciated that multiple instances of these components may be used. For example, various embodiments may include a plurality of requestor devices 102a and dispenser devices 102b. Also, “requestors” may be referred to as cash recipients, and “dispensers” may be referred to as cash providers. A “requestor” may be an individual that operates a requestor device 102a and a “dispenser” may be an individual that operates a dispenser device 102b during a particular transaction. A “requestor” device 102a may therefore be associated with a device user that is seeking cash. Similarly, a “dispenser” device 102b may be associated with a device user that is providing cash. In this way, person-to-person cash dispending may be enabled by the numerous users of person-to-person cash dispending-enabled devices. The requestor and dispensers may be connected through, for example, various social networks. Moreover, the system 100 may include other devices not depicted in FIG. 1.

Example embodiments of system 100 may include location processor 104, transaction processor 105, security processor 106, communication processor 109, and/or contacts processor 111 as stand-alone components, or combined separately from financial institution 101. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The one or more network-enabled computer systems also may include one or more software applications, such as Social Cash application 103, to enable mobile device users to act as cash dispensers for other mobile device users. In various embodiments, Social Cash application 103 may be integrated into a native mobile banking application and/or a mobile optimized web site associated with a financial institution, for example.

The components depicted in FIG. 1 may store information in various electronic storage media, such as database 107. Electronic information, files, and documents may be stored in various ways, including, for example, a flat file, indexed file, hierarchical database, relational database, such as a database created and maintained with software from, for example, Oracle® Corporation, a Microsoft® SQL system, an Amazon cloud hosted database or any other query-able structured data storage mechanism.

Social networking site 110 may be one or more websites and/or mobile device applications that allow a user to create an account and provide user-specific information, including interests, and network with other users based on social connections. Examples of social networking sites/applications may include, without limitation, Facebook, MySpace, Instagram, Google+, LinkedIn, Twitter, Pintrest, and/or the like. Each user may have one or more accounts with associated account data. User account data may include, without limitation, contact information for the user's friends or associates on the social networking site, the user's gender, age, relationship status, family members, interests, hobbies, social groups that the user is a member of, entertainment preferences, political views, religious beliefs, favorite sports teams, and geographic location. The user's account data may be stored in a database.

The components depicted in FIG. 1 may be coupled via one or more networks, such as, for example, network 108. Network 108 may be one or more of a wireless network, a wired network or any combination of wireless network and wired network. For example, network 108 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal. Network 108 may comprise one or more secure communication channels for securely exchanging information between requestor device 102a, dispenser device 102b, and financial institution 101.

In addition, network 108 may include, without limitation, telephone lines, fiber optics, IEEE Ethernet 902.3, a wide area network (“WAN”), a local area network (“LAN”), or a global network such as the Internet. Also network 108 may support an Internet network, a wireless communication network, a cellular network, or the like, or any combination thereof. Network 108 may further include one network, or any number of the example types of networks mentioned above, operating as a stand-alone network or in cooperation with each other. Network 108 may utilize one or more protocols of one or more network elements to which they are communicatively coupled. Network 108 may translate to or from other protocols to one or more protocols of network devices. Although network 108 is depicted as a single network, it should be appreciated that according to one or more embodiments, network 108 may comprise a plurality of interconnected networks, such as, for example, the Internet, a service provider's network, a cable television network, corporate networks, and home networks.

In various example embodiments, dispenser device 102b and requestor device 102a may be associated with any individual or entity that desires to conduct, for example, a person-to-person financial transaction. Financial institution 101 may be, for example, a bank, other type of financial institution, including a credit card provider, for example, or any other entity that offers accounts to customers. An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, savings account, rewards account, line of credit account, credit account, mobile device account, an account or service that links to an underlying payment account already described, or mobile commerce account. An account may or may not have an associated card, such as, for example, a credit card for a credit account or a debit card for a debit account. The account may enable payment using biometric authentication, or contactless based forms of authentication, such as QR codes or near-field communications. The account card may be associated or affiliated with one or more social networking sites, such as a co-branded credit card.

Requestor device 102a and dispenser device 102b may be, for example, a handheld PC, a phone, a smartphone, a PDA, a tablet computer, or other device. Devices 102a and 102b may include device-to-device communication abilities (shown as element 102c). Element 102c may include RFID transmitters and receivers, cameras, scanners, and/or Near Field Communication (NFC) capabilities, which may allow for communication with other devices by touching them together or bringing them into close proximity. Example NFC standards include ISO/IEC 18092:2004, which defines communication modes for Near Field Communication Interface and Protocol (NFCIP-1). For example, devices 102a and 102b may be configured using the Isis Mobile Wallet™ system, which is incorporated herein by reference. Other example NFC standards include those created by the NFC Forum. Element 102c may use Bluetooth technology built into devices 102a and/or 102b. Element 102c may use iBeacon technology and/or Bluetooth Low Energy (BLE) capabilities.

It should be noted that there does not need to be anything different about requestor device 102a and dispenser device 102b. The devices may be interchangeable. As described above, the terms “requestor” and “dispenser” simply refer to the respective roles that the users of the devices may play in relation to one other during a particular transaction. A “requestor” may refer to a user of a device who wishes to obtain physical cash from one or more individuals within his or her social networks and is willing to make a digital payment to a second user in exchange for physical cash from the second user. A “dispenser” may refer to a user of a device who is carrying physical cash and is willing to provide that cash to the requestor in exchange for a digital payment.

Devices 102a and 102b may include one or more software applications, such as Social Cash application 103. Social Cash application 103 may be a software application that enables devices 102a and 102b to securely exchange data with each other, network 108, financial institution 101, social networking site 110, location processor 104, transaction processor 105, communication processor 109, contacts processor 111, and/or security processor 106. Social Cash application 103 may provide one or more graphical user interfaces for the users of requestor device 102a and dispenser device 102b to locate each other and securely exchange physical cash for a digital payment. Social Cash application 103 may be, for example, a native application that executes on a mobile device. Social Cash application 103 may also be integrated into, for example, a native mobile banking application and/or mobile optimized web site that allows the user of requestor device 102a and dispenser device 102b to access an account with financial institution 101.

The user of requestor device 102a may have one or more accounts with financial institution 101. The user of requestor device 102a may use social cash application 103 to link his account to transaction processor 105 and allow transaction processor 105 to use the account for digital payments to a dispenser. The user of dispenser device 102b may do the same.

Contacts processor 111 may be configured to allow the user of requestor device 102a to link his user account data from social networking site 110 with an account with financial institution 101. The user may access social cash application 103 on requestor device 102a. Social cash application 103 may include one or more functions allowing social contacts processor 111 to access the user's contacts from the user's profile (or profiles) on social networking site 110. The user, using for example an API provided by social networking site 110, may provide his login information for social networking site 110 to contacts processor 111. Contacts processor 111 may use the login information (e.g., a username and/or password) to access the user's contacts from social networking site 110. The user's contacts may include usernames, profile names, email addresses, physical addresses, phone numbers, and other information unique to one or more individuals who are part of the user's social networks on social networking site 110.

Contacts processor 111 may be configured to create a “trusted contacts” list in response to one or more signals from requestor device 102a. The trusted contacts list may comprise, for example, contact information for one or more contacts from the user's social networking profile. Contacts processor 111 may save the “trusted contacts” list in database 107 and associate it with the account of requestor device 102a. The user of requestor device 102a may designate which contacts are “trusted contacts” using social cash application 103.

In an example embodiment, location processor 104 may receive location data from devices 102a and 102b. Devices 102a and 102b may include geolocation technology, such as GPS, and broadcast their respective locations to location processor 104. Location processor 104 may pinpoint the location of devices 102a and 102b (along with other devices). Location processor may determine nearby addresses (street, city, zip code, state, country, etc.) corresponding to the location of devices 102a and 102b. Social cash application 103 may prompt the user to allow the location processor 104 to receive location data for requestor device 102a. The user of device 102a may access Social Cash application 103 on device 102a and provide login information. The login information, such as a username and a password, may be associated with a financial account at financial institution 101. The account information may be stored at database 107. The financial account may provide the person-to-person cash dispensing services disclosed herein. Contacts processor 111 may associate the user's social networking profile with the financial account.

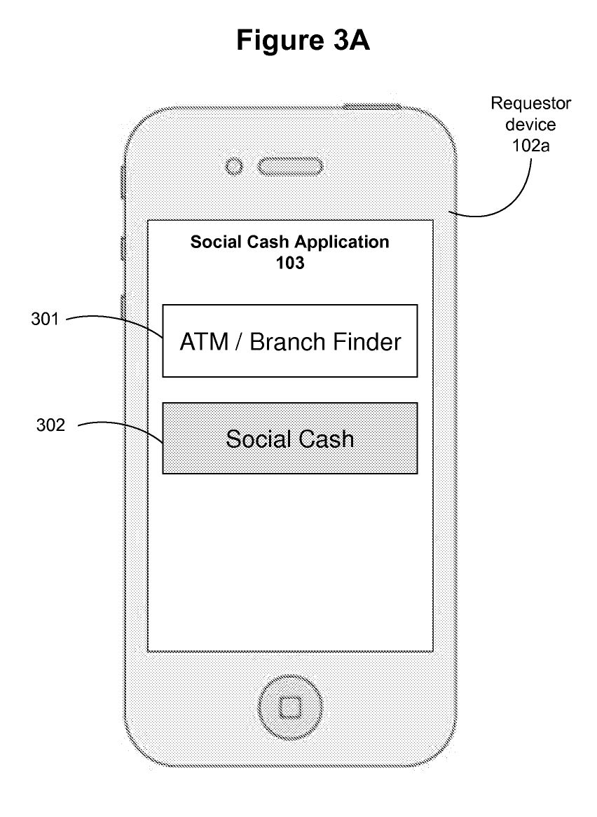

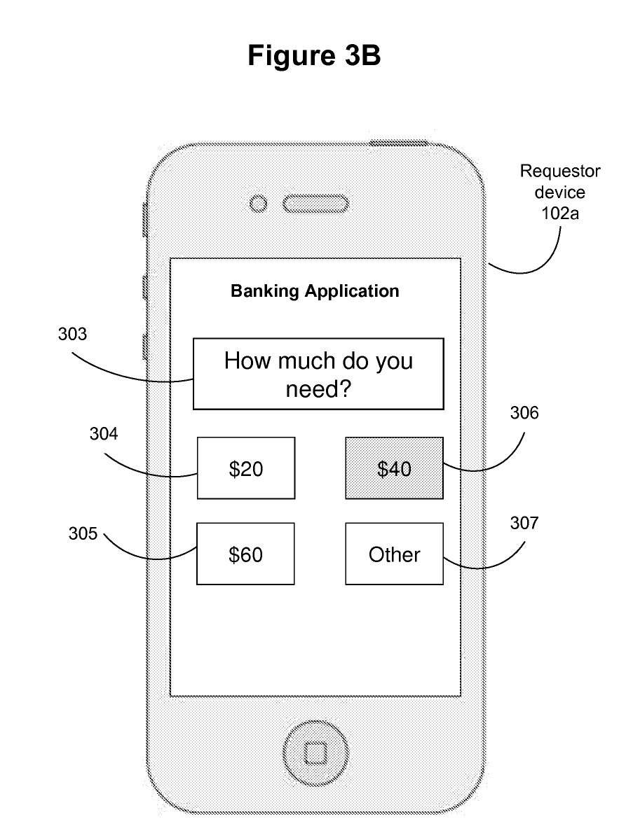

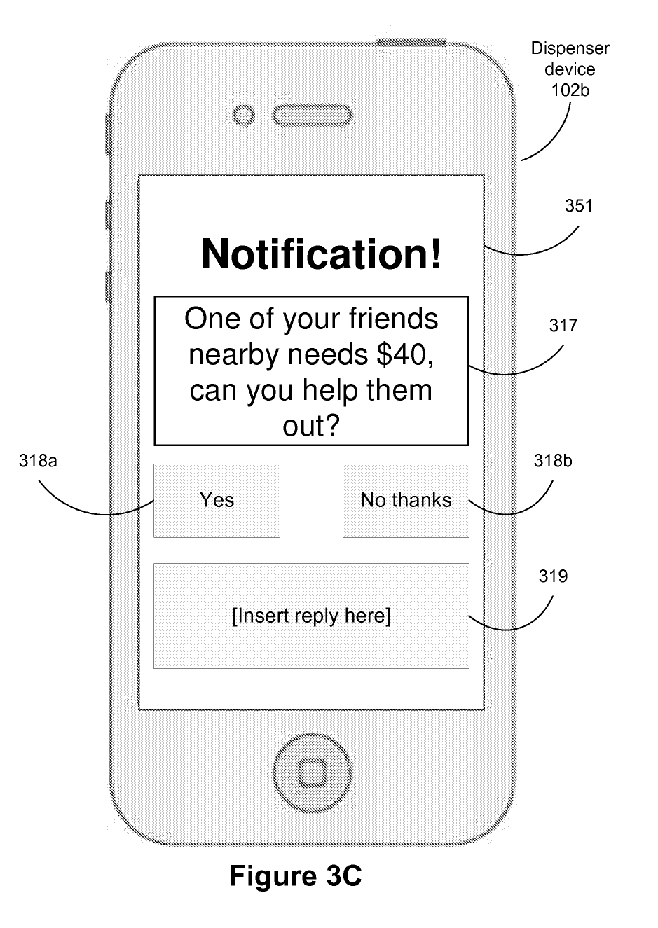

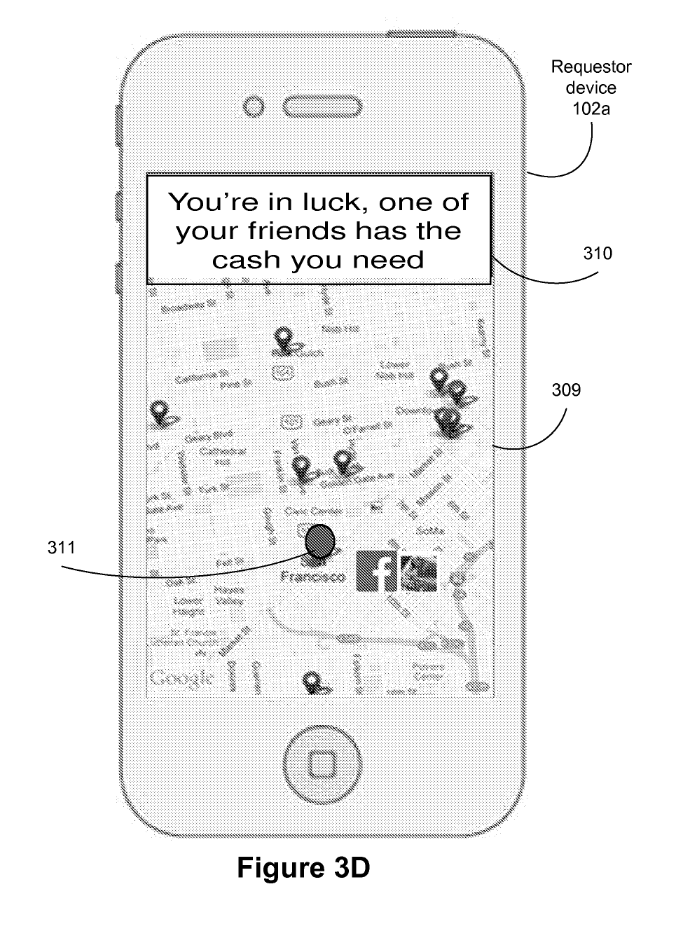

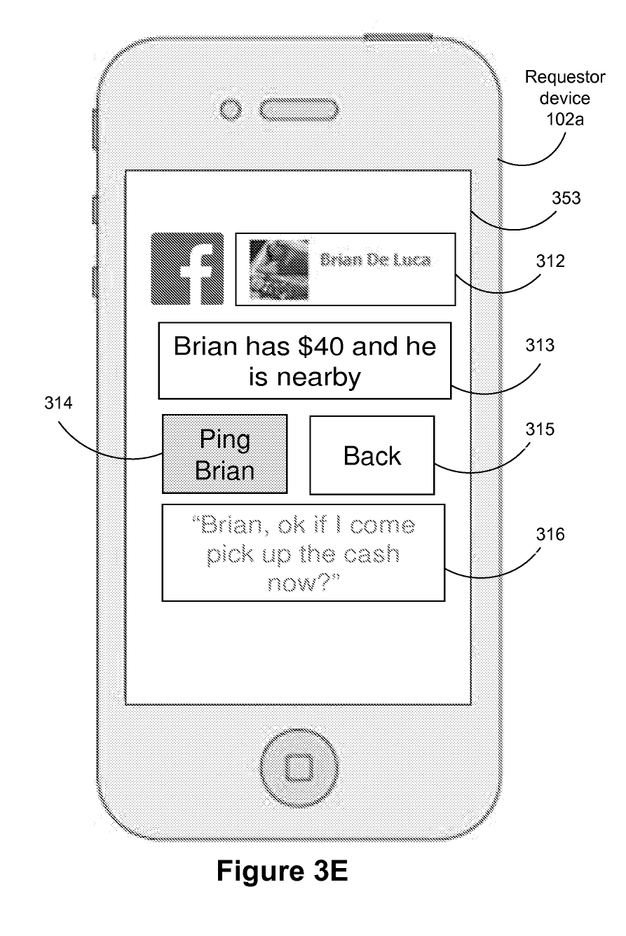

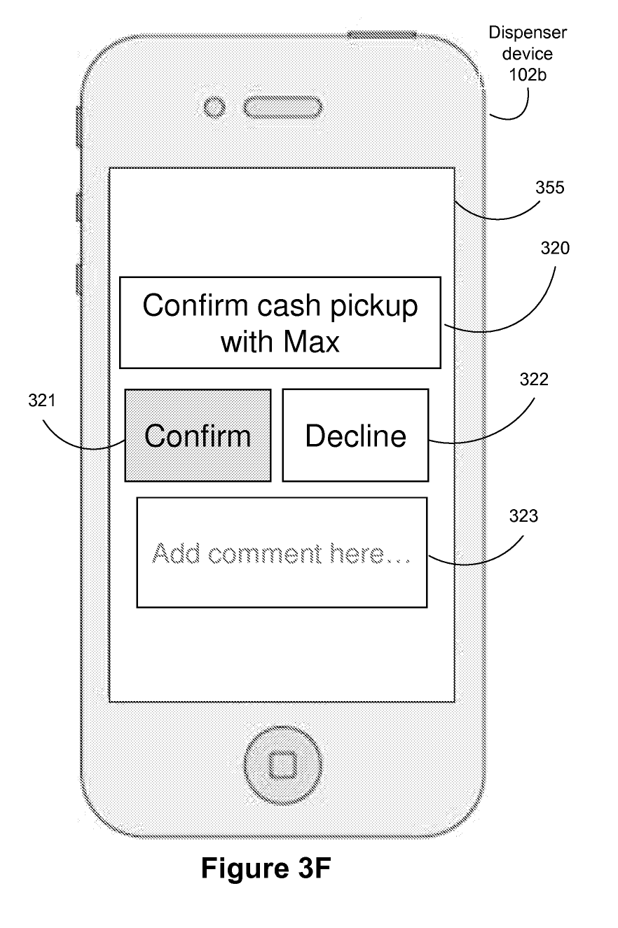

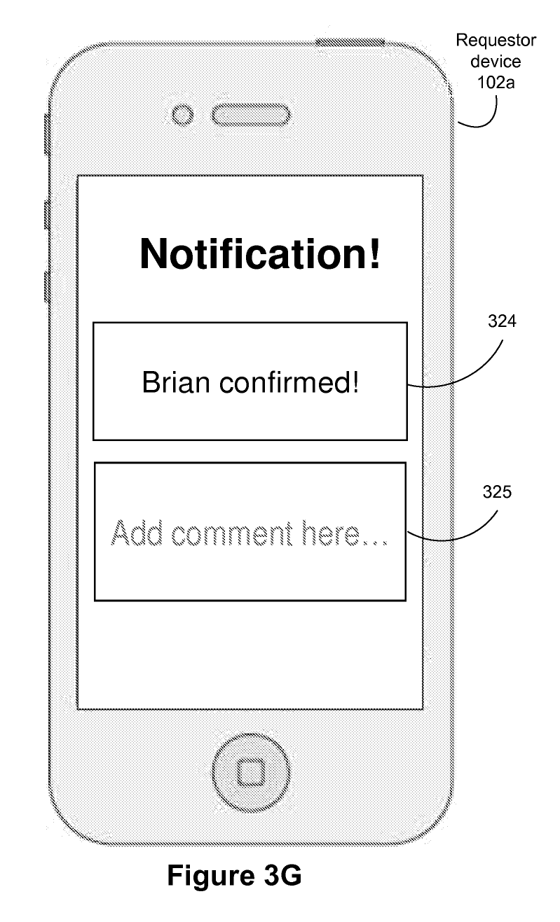

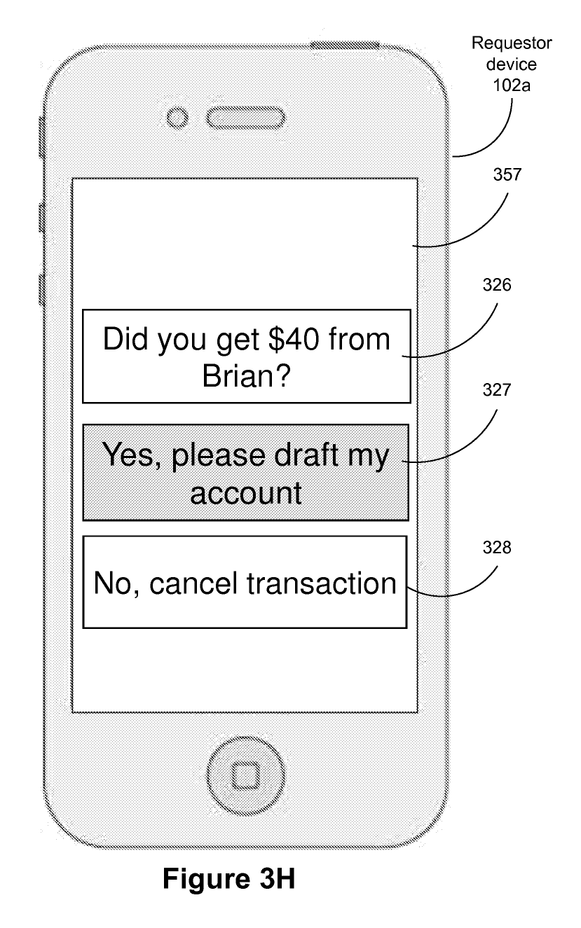

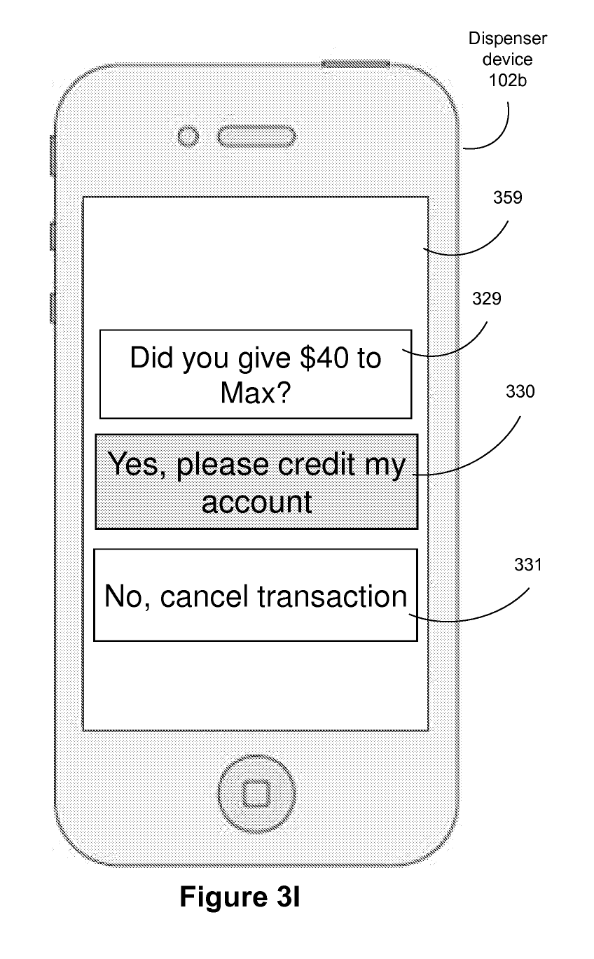

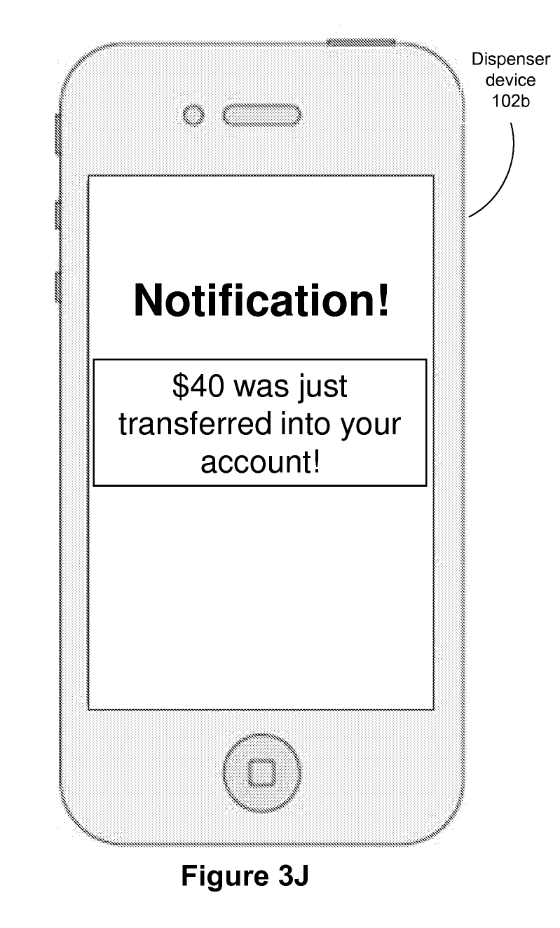

The user of requestor device 102a may access Social Cash application 103 on device 102a and indicate that he is looking for a person-to-person cash dispenser or mobile ATM from his contacts list. An example interface is shown in FIG. 3A. As shown in FIG. 3A, following login, the user of requestor device 102a may be presented with a screen on Social Cash application 103 with options that allow the user to either find a stationary ATM or branch (option 301), or to use the “Social Cash” feature (option 302). If the user selects option 301, social cash application 103 may display a list of nearby ATM's and/or bank locations, based on the location of requestor device 102a (received by location processor 104). If the user selects the “social cash” option 302, social cash application 103 may present the screen shown in FIG. 3B.

In FIG. 3B, social cash application 103 presents an interface on requestor device 102a which requests information from the user “How much do you need?” in box 303. The screen may present default options 304, 305, and 306. If the user is looking for a different amount, he may select option 307 and be presented with an interactive box where he can enter the amount of cash he is seeking. The user's selection of one of options 304-307 may be received by transaction processor 105. In response, transaction processor 105 may retrieve requestor device 102a's current location from location processor 104.

Social contacts processor 111 may retrieve the contacts for the account associated with requestor device 102a and provide them to social cash application 103. The user may be given the option of selecting which contacts he would like to be included in the social cash search. For example, the user may choose to only include “trusted contacts” in the search. The user may select other filters (e.g., “friends”, “work associates”, “family members”). Requestor device 102a may specify the distance (using his social cash application 103)—indicating how far he is willing to travel to get cash (e.g., 0.25 miles, 1 mile, within a certain city or zip code, etc.).

Transaction processor 105 may then request location information from location processor 104 for any device associated with one of the contacts provided by contacts processor 111. Location processor 104 may use various location services associated with requestor device 102a to locate contacts. For example, location processor 104 may use various “find friends” application on requestor device 102a. Transaction processor 105 may limit the search based on the contacts designated by the user as described above (e.g., limited to “trusted contacts”). Transaction processor 105 may limit the search based on distance information provided by requestor device 102a (e.g., only search for devices within a 1 mile radius of requestor device 102a's location). Location processor 104 may receive location information for other user devices nearby requestor device 102a.

Other limitations may be imposed on the search radius. For example, certain geographic areas may be considered unsafe (e.g., high crime areas, industrial areas). Transaction processor 105 may be configured to block user devices that are located within those regions from being displayed in the search results on requestor device 102a. Social cash application 103 may be configured to allow the user of requestor device 102a to set these limitations him or herself.

Location processor 104 may periodically receive the updated locations of user devices associated with each contact within the contact list provided to contacts processor 111 from social networking site 110. The locations of each user device may be periodically received from social networking site 110, or directly from the devices themselves. In some embodiments, the users associated with these devices may receive an authorization request from communication processor 109 around the time requestor device 102a first creates the contact list using social cash application 103 (i.e., when contacts processor 111 first accesses the contacts stored at social networking site 110). The authorization request may inform the contact that requestor device 102a has placed them in a contacts list for a social cash application, and request the permission from that user device to proceed. For example, the authorization request may inform the user that “Brian wants to include you as a potential cash dispenser. Do you agree?” The user may have the option of requesting additional information about the social cash application. The user may have the option of downloading the social cash application 103 (if he does not already have it on his user device). If the user device responds affirmatively to the authorization request, then the location for that user device will be periodically provided to location processor 104. If the user device declines to grant authorization, then that contact will be removed from the contacts list stored at contacts processor 111, thus making that user device's location effectively invisible to location processor 104.

In other embodiments, users could access the social cash application 103 on their devices and opt-in as a dispenser device 102b. The process would work in a similar manner as described above (e.g., the user would provide contacts to contacts processor 111), and the devices would act as passive dispenser devices and be available to be included in a search request sent out by a requestor device associated with one of the contacts in their contacts list.

Returning to FIG. 3B, once transaction processor 105 receives an indication that the requestor device 102a is looking to receive cash from a contact in the contacts list, transaction processor 105 may compare requestor device 102a's location to the location of each device associated with a user in the contact list from contacts processor 111. If transaction processor 105 locates one or more devices that are within a certain distance of requestor device 102a (and are associated with a contact in the contacts list from contacts processor 111), transaction processor 105 may designate these devices as potential dispenser devices, and communications processor 109 may transmit a notification to each of the potential dispenser devices in the area. An embodiment of the notification is shown in FIG. 3C.

FIG. 3C shows an example embodiment of a notification 351 received by a dispenser device 102b. Dispenser device 102b may be a device associated with a contact in the contact list, where the device 102b is located within the search radius of requestor device 102a, as described above. The notification 351 may be sent in the form of a text message, email, tweet, Facebook message, SMS, MMS, or other electronic message or via notification on the screen of dispenser device 102b. The example notification 351 in FIG. 3C is shown as a graphic display within a mobile application, for example. A person of ordinary skill in the art would understand that similar notifications including the aforementioned notifications may be used. The notification 351 may include box 317 informing the user of dispenser device 102b that a friend is nearby and is looking for cash. Box 317 may inform the user how much cash ($40 in this example), and may provide the name of the user of requestor device 102a. The notification 351 may include one or more interactive response options 318a, 318b, and/or 319. The user of dispenser device 102b may respond “yes” (option 318a). The user of dispenser device 102b may type in a reply in box 319 and send it to dispenser device 102a via communications processor 109.

If dispenser device 102b responds “yes” (option 318a), this response may be sent to communications processor 109, and then to requestor device 102a. Upon receiving this response, social cash application 103 may display an interactive map to requestor device 102a showing the location of dispenser device 102b, as shown in the embodiment shown in FIG. 3D. In various embodiments, the user of dispenser device 102b may have the option of responding with a proposed meeting location instead of or in addition to his current location. The user of dispenser device 102b may select a location on an interactive map included with the notification, and the response may be sent to communications processor 109 and then to requestor device 102a. Social cash application 103 may display an interactive map 309 on requestor device 102a showing the proposed meeting location, but not the current location of dispenser device 102b. This map 309 may be generated, for example, by transaction processor 105, location processor 104, and/or communications processor 109. If the dispenser device 102b responds “no” (option 318b), then the location of dispenser device 102b will not be shown on the map generated for requestor device 102a. In various embodiments, the map 309 in FIG. 3D may be generated and displayed before dispenser device 102b receives the notification shown in FIG. 3C.

As shown in FIG. 3D, the location of each device that responded affirmatively to the notification shown in FIG. 3C will be displayed on a map 309 for requestor device 102a. The map 309 may show the location 311 of the dispenser device 102b (or the locations of each of a plurality of dispenser devices that responded affirmatively to the notification). The map 309 may include a notification 310 informing requestor device 102a of the name (or names) of the contacts who are nearby and are willing to provide cash. The map 309 may include the names, profile names, pictures, and other contact information associated with each nearby dispenser device 102b that is depicted on map 309. The user of requestor device 102a may select the dispenser device 102b that he or she wants to use to receive cash using the interactive map 309. Once the user has selected a dispenser device 102b, transaction processor 105 and/or communications processor 109 may provide means for the user of requestor device 102a to communicate with dispenser device 102b in order to complete the transaction, as shown in FIGS. 3E-3J.

FIG. 3E shows an embodiment of a notification 353 sent from communication processor 109 to requestor device 102a that includes information allowing the user of requestor device 102a to connect with dispenser device 102b. The notification 353 may include the name and/or contact information for the user associated with dispenser device 102b (shown in box 312). The notification may include box 313 tell requestor device 102a the name of the user associated with dispenser device 102b (in this example, “Brian”) and the amount of cash he has available (in this example, $40). The notification 353 may include box 314 that allows requestor device 102a to contact dispenser device 102b (“Ping Brian”) in order to confirm a meeting with the user of dispenser device 102b. If the user of requestor device 102a selects box 314, communication processor 109 may send a message to dispenser device 102b to setup a location to meet. The message may include a map showing the locations of requestor device 102a and dispenser device 102b. As shown in FIG. 3E, box 316 may include an interactive text entry area where the user of requestor device 102a can send a personalized message to dispenser device 102b to arrange a meeting. If the user selects the “back” option 315, map 309 may be displayed, and the user may select a different dispenser device (if other dispenser devices are in the area).

FIG. 3F shows an example embodiment of a notification 355 received by dispenser device 102b once the user of requestor device 102a has selected option 314 and/or 316 (from FIG. 3E). The user of dispenser device 102b (in this example, “Brian”) may select option 320 to confirm a physical meeting with the user of requestor device 102a (in this example, “Max”). The user may select option 321 to decline. The user may send a personalized message to requestor device 102a using box 322. The users also may be able to set up a meeting using a date/time/location feature, for example. If dispenser device 102b confirms, requestor device 102a may receive a notification such as the one shown in the embodiment of FIG. 3G. These notifications may be sent between the user devices via communication processor 109.

Once the user associated with requestor device 102a and the user associated with dispenser device 102b physically meet to exchange cash, communication processor 109 may send one or more notifications to each device to help facilitate the transaction. FIGS. 3H-3J show example embodiments of screenshots on the user devices to help facilitate this exchange.

FIG. 3H depicts an example embodiment of a screenshot 357 on requestor device 102a that includes an authorization request 326 that checks whether the user (“Max”) received the cash from the user of the dispenser device 102b. The request 326 is personalized and includes the name of the user associated with the dispenser device 102b (“Brian”) and the amount of cash ($40). If Max selects box 327, security processor 106 may confirm the transaction, and transaction processor 105 may initiate a credit of $40 from the financial account associated with requestor device 102a to an account associated with dispenser device 102b. If the user selects option 328, security processor 106 may prevent a transaction. Security processor 106 may receive location data for devices 102a and 102b and determine whether the devices were within a certain distance of each other (i.e., to determine if the users actually met and could have physically exchanged cash). If the devices were not within a predetermined distance, security processor 106 may prevent the digital payment from being completed. In various embodiments, security processor 106 will require both devices to send a transaction confirmation within a predetermined time before security processor 106 allows the digital payment to occur.

FIG. 3I depicts an example embodiment of a screenshot 359 on dispenser device 102b that includes an authorization request 329 that checks whether the user (“Brian”) gave the cash from the user of the requestor device 102a. The request 329 may be personalized and include the name of the user associated with the requestor device 102a (“Max”) and the amount of cash ($40). If Brian selects box 330, security processor 106 may confirm the transaction, and transaction processor 105 may initiate a credit of $40 from an account associated with requestor device 102a to an account associated with dispenser device 102b. If the user selects box 331, security processor 106 may prevent a transaction from occurring. Security processor 106 may require both requestor device 102a and dispenser device 102b to confirm that the transaction occurred before initiating a transfer from an account associated with requestor device 102a to an account associated with dispenser device 102b. The notification may also include one or more interactive features allowing the user of dispenser device 102b to designate the financial account that will receive the digital payment.

If the transaction is confirmed by one or both parties, transaction processor 105 may initiate the transfer of funds in the form of a digital payment from an account associated with requestor device 102a to an account associated with dispenser device 102b. The digital payment may be accomplished via transaction processor 105 over network 108. The devices also may directly exchange a digital payment using device-to-device technology 102c (e.g., NFC, bluetooth, etc.). The digital payment from requestor device to dispenser device may be in the form of an ACH transfer. If both requestor device and dispenser device have accounts with financial institution 101, the digital payment may be a direct credit. The digital payment may be credited to a mobile wallet associated with the dispenser device. The payment may not be in the form of digital cash. The payment may be a token. The payment also may be in the form of rewards points or credits. The digital payment may occur in real-time. FIG. 3J shows an embodiment of a screenshot on dispenser device 102b based on one or more signals from communication processor 109 indicating that the account associated with dispenser device 102b has been credited in the amount of the transaction.

In various example embodiments, transaction processor 105 may require the user of requestor device 102a to maintain some account with a minimum account balance to act as security in the event that the user associated with requestor device 102a receives physical cash from another but does not confirm the transaction and thus prevents the dispenser device 102b from receiving a digital payment. In this example, if the user associated with dispenser device 102b files a complaint or claim for payment, transaction processor 105 may debit the account associated with requestor device 102a for the correct amount and credit the account associated with dispenser device 102b.

In various embodiments, there may be an associated transaction fee for dispensing cash. The transaction fee may be a flat rate (e.g., $1.50 per transaction). The transaction fee may be a percentage of the transaction amount (e.g., 2%). The user of a dispenser device may set the transaction fee using social cash application 103. The user may negotiate the transaction fee with the user of requestor device 102a. The transaction fee may be stored with his or her profile information in database 107. When requestor device 102a searches for available dispenser devices, the user of requestor device 102a may use social cash application 103 to specify that it does not want to see dispenser devices that charge a transaction fee of more than $2.00. Transaction processor 105 may impose limits on the transaction fees that can be charged by the dispenser devices.

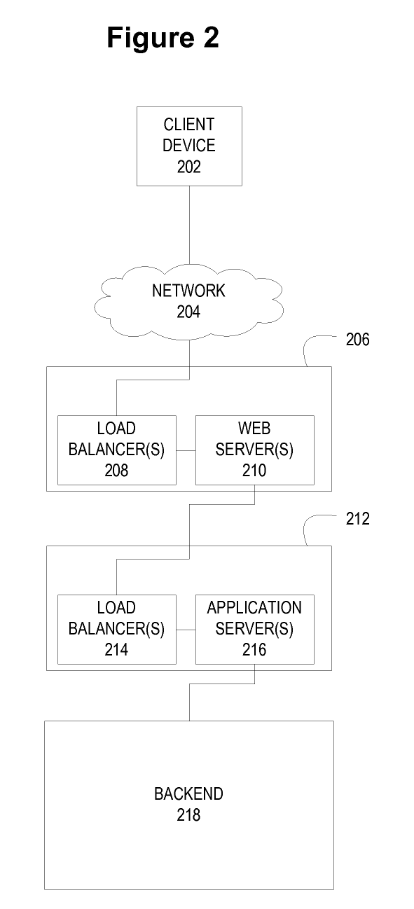

FIG. 2 depicts an example system 200 that may enable individuals to act as a mobile ATMs and provide physical cash to other individuals in exchange for digital payment. As shown in FIG. 2, system 200 may include a client device 202, a network 204, a front-end controlled domain 206, a back-end controlled domain 212, and a backend 218. Front-end controlled domain 206 may include one or more load balancers 208 and one or more web servers 210. Back-end controlled domain 212 may include one or more load balancers 214 and one or more application servers 216.

Client device 202 may be a network-enabled computer. Client device 202 may be similar to requestor device 102a and/or dispenser device 102b. Client device 202 may be configured to execute social cash application 103. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 200 may execute one or more software applications to enable, for example, network communications.

Client device 202 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 204 may be one or more of a wireless network, a wired network, or any combination of a wireless network and a wired network. For example, network 204 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 204 may include, without limitation, telephone lines, fiber optics, IEEE Ethernet 902.3, a wide area network (WAN), a local area network (LAN) or a global network such as the Internet. Also, network 110 may support an Internet network, a wireless communication network, a cellular network, or the like, or any combination thereof. Network 204 may further include one network, or any number of example types of networks mentioned above, operating as a stand-alone network or in cooperation with each other. Network 204 may utilize one or more protocols of one or more network elements to which they are communicatively couples. Network 204 may translate to or from other protocols to one or more protocols of network devices. Although network 204 is depicted as a single network, it should be appreciated that according to one or more embodiments, network 204 may comprise a plurality of interconnected networks, such as, for example, the Internet, a service provider's network, a cable television network, corporate networks, and home networks.

Front-end controlled domain 206 may be implemented to provide security for backend 218. Load balancer(s) 208 may distribute workloads across multiple computing resources, such as, for example computers, a computer cluster, network links, central processing units or disk drives. In various embodiments, load balancer(s) 208 may distribute workloads across, for example, web server(S) 210 and/or backend 218 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 208 and 214 may include software that monitoring the port where external clients, such as, for example, client device 202, connect to access various services of a financial institution or third party that provides the social cash services (such as system 100 shown in FIG. 1), for example. Load balancer(s) 208 may forward requests to one of the application servers 216 and/or backend 218 servers, which may then reply to load balancer 208. This may allow load balancer(s) 208 to reply to client device 202 without client device 202 ever knowing about the internal separation of functions. It also may prevent client devices from contacting backend servers directly, which may have security benefits by hiding the structure of the internal network and preventing attacks on backend 218 or unrelated services running on other ports, for example.

A variety of scheduling algorithms may be used by load balancer(s) 208 to determine which backend server to send a request to. Simple algorithms may include, for example, random choice or round robin. Load balancers 208 also may account for additional factors, such as a server's reported load, recent response times, up/down status (determined by a monitoring poll of some kind), number of active connections, geographic location, capabilities, or how much traffic it has recently been assigned.

Load balancers 208 may be implemented in hardware and/or software. Load balancer(s) 208 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 210 may include hardware (e.g., one or more computers) and/or software (e.g., one or more applications) that deliver web content that can be accessed by, for example a client device (e.g., client device 202) through a network (e.g., network 204), such as the Internet. In various examples, web servers, may deliver web pages, relating to, for example, online banking applications and the like, to clients (e.g., client device 202). Web server(s) 210 may use, for example, a hypertext transfer protocol (HTTP or sHTTP) to communicate with client device 202. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 210 may respond with the content of that resource or an error message if unable to do so. The resource may be, for example a file on stored on backend 218. Web server(s) 210 also may enable or facilitate receiving content from client device 202 so client device 202 may be able to, for example, submit web forms, including uploading of files.

Web server(s) also may support server-side scripting using, for example, Active Server Pages (ASP), PHP, or other scripting languages. Accordingly, the behavior of web server(s) 210 can be scripted in separate files, while the actual server software remains unchanged.

Load balancers 214 may be similar to load balancers 208 as described above.

Application server(s) 216 may include hardware and/or software that is dedicated to the efficient execution of procedures (e.g., programs, routines, scripts) for supporting its applied applications. Application server(s) 216 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 216 may act as a set of components accessible to, for example, a financial institution or other entity implementing system 200 and/or system 100, through an API defined by the platform itself. For Web applications, these components may be performed in, for example, the same running environment as web server(s) 210, and application servers 216 may support the construction of dynamic pages. Application server(s) 216 also may implement services, such as, for example, clustering, fail-over, and load-balancing. In various embodiments, where application server(s) 216 are Java application servers, the web server(s) 210 may behaves like an extended virtual machine for running applications, transparently handling connections to databases associated with backend 218 on one side, and, connections to the Web client (e.g., client device 202) on the other.

Backend 218 may include hardware and/or software that enables the backend services of, for example, a financial institution or other entity that maintains a distributes system similar to system 200 and/or system 100. For example, backend 218 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, a mobile ATM system (e.g., system 100 shown in FIG. 1) and the like. Backend 218 may be associated with various databases, including account databases that maintain, for example, customer account information, product databases that maintain information about products and services available to customers, content databases that store content associated with, for example, a financial institution, and the like. Backend 218 also may be associated with one or more servers that enable the various services provided by system 200. Backend 218 may be associated with one or more servers that enable the various services provided by system 100.

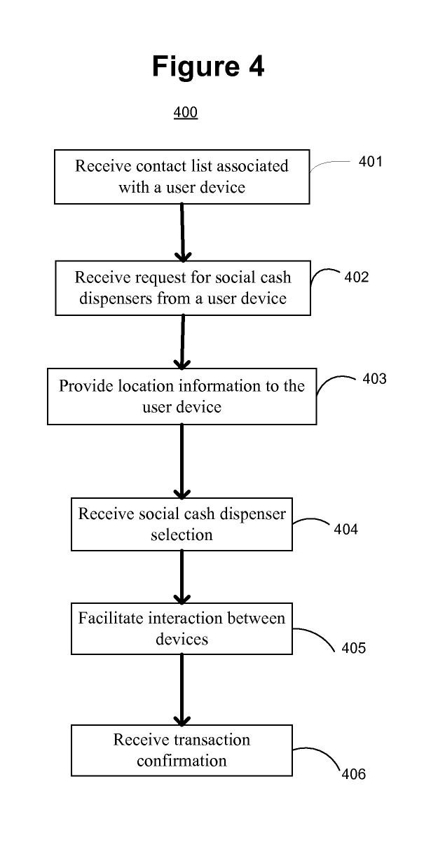

FIG. 4 is a flow chart illustrating an example method for enabling individuals to act as a person-to-person cash dispenser or mobile ATM and provide cash to nearby individuals in exchange for a digital payment. The method 400 shown in FIG. 4 can be executed or otherwise performed by one or more combinations of various systems. The method 400 as described below may be carried out by the system for enabling individuals to act as a person-to-person cash dispenser or mobile ATM and provide cash for nearby individuals in exchange for a digital payment, as shown in FIGS. 1, 2 and 3A-3J, by way of example, and various elements of that system are referenced in explaining the method of FIG. 4. Each block shown in FIG. 4 represents one or more processes, methods, or subroutines in the example method 400. Referring to FIG. 4, the example method 400 may begin at block 401.

At block 401, contacts associated with a user device may be received. The contacts may be social networking contacts. The contacts may be names, usernames, and profile information for individuals that are connected to the user associated with the user device on one or more social networks. The user may provide his social network usernames and passwords to social cash application 103. Transaction processor 105 and/or contacts processor 111 may access one or more social network profiles for the user and retrieve profile information associated with friends, family members, co-workers, professional contacts, and other social networking contacts. The user may designate certain contacts as “trusted contacts”. Contacts processor 111 may maintain a list of contacts for the user. Location processor 104 may periodically receive location data for these contacts (based on the locations of the mobile devices those contacts are using). These contacts may be designated as social cash dispensers. Method 400 may proceed to block 402.

At block 402, a request from the user device for nearby social cash dispensers may be received. A cash dispenser may be another nearby individual who has excess cash available and is willing to exchange it for a digital payment. The user of the user device (the requestor device) may be in need of physical cash. The request may be sent using social cash application 103. The request may include the user's location, how much money the user needs or wants, and any limitations on the search. In one example, a user (Bob) may be at a baseball game with his son, only to discover that he does not have enough cash to pay for concessions. He may use social cash application 103 on his mobile device to look for nearby cash dispensers. He may have previously supplied his social networking contacts (as shown in block 401). He may request $20. He may limit his search to cash dispensers from his trusted contacts list and within 0.25 miles (or within the stadium).

Based on the search request, a search may be performed for nearby social cash dispensers from Bob's contact list matching the criteria provided by Bob. The social cash system may discover four cash dispensers within the 0.25 mile radius of Bob. The social cash system may send a notification to the device associated with each cash dispenser, informing the user of that device that a nearby individual is looking for $20. The notification may include Bob's name and a link to his social networking profile, or information showing how Bob is linked to the user associated with that device. The notification may request whether the individual associated with the cash dispenser would like to be discoverable by Bob. Method 400 may proceed to block 403.

At block 403, location information for cash dispensers that meet the requirements of the search request and that affirmatively responded to the notification may be provided. The location information may be provided to Bob's mobile device in the form of an interactive map (such as the one shown in FIG. 3D). The interactive map may display Bob's location, along with the location of each cash dispenser (if the user associated with that cash dispenser responded affirmatively to the prior notification requesting permission to display their location in response to Bob's search request). In this example, the closest nearby cash dispenser may be Sally, a user who has available cash.

The interactive map on Bob's device may show the username of each user associated with the cash dispenser. The map may show the distance to that cash dispenser, and the transaction fee associated with that cash dispenser (if any). In this example, Sally may have set a transaction fee of 5%, and may currently be located in the stadium. Method 400 may proceed to block 404.

At block 404, the cash dispenser selection from the user device may be received. In this example, Bob may select Sally's cash dispenser on the interactive map using a touchscreen or keypad on his mobile device. Method 400 may proceed to block 405.

At block 405, interaction between Bob's and Sally's devices may be facilitated. Sally may receive a notification that Bob has selected her cash dispenser for the transaction. Sally and Bob's devices may each receive directions on an interactive map. Bob and Sally may be allowed to communicate directly using social cash application 103 on their mobile devices. The devices may be able to communicate via a phone call, text messages, email, or other forms of communication. The communications may be masked so that neither Bob nor Sally can see the source of the communication. Bob and Sally may exchange messages to set up a place to meet, such as at a certain level and row of the stadium (using one or more interactive notifications, such as those shown in FIGS. 3E-3G). Upon meeting, Sally may provide Bob with $20 cash in exchange for a digital payment from Bob's payment account. The digital payment may be made from Bob's payment account to an account associated with Sally. The payment may be in the form of a cash transfer. In this example, Bob may have $21 transferred to Sally's account ($20 for the cash from Sally, plus $1 for the transaction fee representing 5% of $20). Method 400 may proceed to block 406.

At block 406, receive transaction confirmation may be received. The confirmation may be received from Bob's device, Sally's device, or both. The digital payment may only be made once confirmation is received. Method 400 may end.

It is further noted that the software described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

I claim:

1. A system, comprising:
an application programming interface that receives a contact list;
a communications processor that receives a request for a mobile cash dispenser from a user device;
a location processor that provides location information to the user device indicating the location of one or more mobile cash dispensers, wherein each of the one or more mobile cash dispensers are associated with a respective contact in the contact list;
an input interface that receives a selection from the user device of one of the one or more mobile cash dispensers; and
a social cash processor in cooperation with the communications processor that facilitates an interaction between the user device and the selected mobile cash dispenser and receives transaction confirmation information from at least one of the user device and the mobile cash dispenser.

2. The system of claim 1, further comprising:
a graphical user interface that displays to the user the locations of the one or more mobile cash dispensers on an interactive map.

3. The system of claim 1, further comprising:
a financial transactions processor that processes the transaction after the social cash processor received transaction confirmation information.

4. The system of claim 1, wherein the social cash processor receives the transaction confirmation information after a user of the mobile cash dispenser provides cash to a user of the user device.

5. The system of claim 1, wherein the application programming interfaces with a social network and the client list is associated with a social network profile of a user of the user device.

6. The system of claim 1, wherein, to facilitate the interaction, a graphical user interface prompts a user of the user device to enter an amount of social cash the user seeks and the input interface receives the inputted amount from the input interface.

7. The system of claim 6, wherein to facilitate the interaction, the communication processor transmits the amount to the mobile cash dispenser and receives confirmation that a user of the mobile cash dispenser has the amount in cash to dispenser.

8. The system of claim 1, wherein the user device is associated with a requestor.

9. The system of claim 8, wherein the mobile cash dispenser is associated with a dispenser.

10. The system of claim 9, wherein the mobile cash dispenser includes:
a communications processor that receives a request to dispense cash from the user device and the location of the user device;
a graphical user interface that displays the location of the user device and an amount of cash that a user of the user device seeks;
an input interface that receives an indication from a user of the mobile cash dispenser that the user possesses the requested amount in cash; and
a social cash processor in cooperation with the communications processor that facilitates an interaction between the user device and the mobile cash dispenser and receives transaction confirmation information from the mobile cash dispenser.
